(19) United States
(12) Patent Application Publication
(10) Pub. No.: US 2017/0102046 A1
(43) Pub. Date: Apr. 13, 2017

(54) FLYWHEEL ASSEMBLY

(71) Applicant: HYUNDAI MOTOR COMPANY, Seoul (KR)

(72) Inventor: Wan Soo OH, Yongin-si (KR)

(21) Appl. No.: 15/280,269

(22) Filed: Sep. 29, 2016

(30) Foreign Application Priority Data
Oct. 8, 2015 (KR) 10-2015-0141859

(51) Int. Cl. F16F 15/14; F16F 15/30

(52) U.S. Cl. CPC F16F 15/145; F16F 15/30

(57) ABSTRACT

A flywheel assembly includes a flywheel mounted to a crankshaft of an engine to be integrally rotated therewith, and at least one centrifugal pendulum damper installed to be reciprocally moved inside the flywheel.

### CROSS-REFERENCE TO RELATED APPLICATION

This application claims the benefit of priority to Korean Patent Application No. 10-2015-0141859, filed in the Korean Intellectual Property Office on Oct. 8, 2015, the entire contents of which are incorporated herein by reference.

### TECHNICAL FIELD

The present disclosure relates to a flywheel. More particularly, the present disclosure relates to a flywheel assembly having centrifugal pendulum damper (CPA).

### BACKGROUND

Conventionally, to transmit a rotational power of a vehicle engine, a flywheel is mounted to a crankshaft (an output shaft) of an engine to be integrally rotated therewith, and a transmission input shaft is selectively connected to the flywheel via a clutch. Thus, the rotation power of the engine is selectively transmitted to the transmission input shaft through the flywheel and the clutch depending on the connection or the release state of the clutch.

To smoothly transmit the rotation power of the engine to the transmission input shaft by reducing the abruptness of a rotational change of the crankshaft depending on the torque change of the engine and the torsional vibration of the crankshaft, research for various flywheel designs has been performed.

For example, a dual mass flywheel (DMF) includes a primary flywheel mounted to the crankshaft of the engine, a secondary flywheel mounted to the transmission input shaft, a driving plate connecting the primary flywheel and the secondary flywheel, and an elastic member (spring) elastically supporting the driving plate.

When the rotation power of the engine is transmitted to the transmission input shaft through the primary the flywheel, the driving plate, and the secondary flywheel, the elastic member absorbs the rotational speed changes of the driving plate such that the rotation power of the engine is smoothly transmitted to the transmission.

Due to downsizing and a high power demands of the engine for an enhancement of fuel efficiency, changes of the rotational power of the engine are intensified and a centrifugal pendulum damper (CPA) may be applied for a reduction of the change.

The centrifugal pendulum damper may be formed of a structure wherein at least one pendulum that may be moved in a pendulum movement (simple vibration) by a centrifugal force is installed to a rotation member and a resonance frequency of the pendulum is tuned to match to a frequency of the rotation member to absorb the rotation vibration (torsion vibrations) of the rotation member.

The development of an apparatus for smoothly transmitting the rotation power of the engine to the transmission by applying the centrifugal pendulum damper to the flywheel to absorb the torsion vibration of the flywheel is thus needed.

The above information disclosed in this Background section is only for enhancement of understanding of the background of the disclosure and therefore it may contain information that does not form the prior art that is already known in this country to a person of ordinary skill in the art.

### SUMMARY

An exemplary embodiment of the present disclosure provides a flywheel assembly having a centrifugal pendulum damper for smoothly executing a rotation power delivery of the engine through the flywheel by applying the centrifugal pendulum damper to the flywheel to effectively absorb vibrations of the flywheel.

A flywheel assembly according to an exemplary embodiment of the present disclosure may include a flywheel mounted to a crankshaft of an engine to be integrally rotated with the crankshaft; and at least one centrifugal pendulum damper installed to be reciprocally moved inside the flywheel.

At least one guide groove may be formed at one side of the flywheel; and at least one centrifugal pendulum damper may be received inside the at least one guide groove.

At least one centrifugal pendulum damper and the guide groove may be formed of a circular arc shape.

At least one guide groove and the centrifugal pendulum dampers may be disposed at a predetermined interval along a circumferential direction of the flywheel.

At least one guide groove and the centrifugal pendulum dampers may be disposed near an outer edge in a radial direction of the flywheel.

A width and a length of the centrifugal pendulum dampers may be smaller than a respective width and length of the guide groove.

A buffer damper may be attached to a front end part of both sides of the flywheel along a circumferential direction of the guide groove.

A needle bearing or a roller may be mounted to an outer edge of a radial direction of the centrifugal pendulum damper.

The flywheel may be installed with a cover to prevent at least one centrifugal pendulum damper from being separated from the flywheel.

At least one centrifugal pendulum damper may include at least one protrusion to reduce a friction between the centrifugal pendulum damper and the cover.

The cover may be formed of a ring shape.

A roller receiving groove may be formed at the outer edge of the radial direction of the centrifugal pendulum damper.

According to the flywheel assembly of an exemplary embodiment of the present disclosure, at least one pendulum having a reciprocal motion may be provided inside the flywheel such that the at least one pendulum is vibrated in an inverse phase with respect to a vibration of the flywheel to absorb and offset the vibration of the flywheel, thereby effectively reducing the vibrations of the flywheel.

Also, the rotation power of the engine may be stably and smoothly transmitted to the transmission through the flywheel by the reduction of the vibrations of the flywheel.

Particularly, the acceleration vibration of the flywheel may be reduced by more than 30% such that the acceleration vibrations of the transmission transmitted with the rotation power, or a rotational speed change, of the engine through the flywheel may be reduced.

When at least one pendulum is vibrated inside the flywheel, the flywheel and at least one pendulum may be prevented from being conflicted, or contacted, directly through at least one damper attached inside the flywheel such that a crash impact noise may be reduced.

Also, since it is not necessary to use a conventional dual mass flywheel, a cost and a weight may be reduced, because the at least one pendulum installed inside the flywheel may be easily applied without increasing the weight or the size of the flywheel, the entire length of the power delivery system, and the like.

### BRIEF DESCRIPTION OF THE DRAWINGS

FIG. 1 is a cross-sectional view of a flywheel and a crankshaft including a centrifugal pendulum damper according to an exemplary embodiment of the present disclosure.

FIG. 2 is an exploded front view of a flywheel assembly of a centrifugal pendulum damper according to an exemplary embodiment of the present disclosure.

FIG. 3 is a perspective view of a centrifugal pendulum damper according to an exemplary embodiment of the present disclosure.

FIG. 4 is a perspective view of a centrifugal pendulum damper according to an exemplary embodiment of the present disclosure.

FIG. 5 is a front view and a lateral view of a centrifugal pendulum damper according to an exemplary embodiment of the present disclosure

### DETAILED DESCRIPTION

Hereinafter, an exemplary embodiment of the present disclosure will be described in detail with reference to the accompanying drawings.

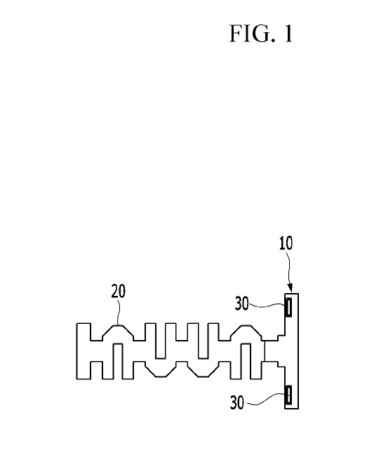

Referring to FIG. 1, a flywheel assembly according to an exemplary embodiment of the present disclosure may include a flywheel 10 mounted to a front end part of one side of a crankshaft 20 of an engine to be integrally rotated therewith.

The crankshaft 20 may be connected to a piston (not shown) of the engine via a connecting rod, thereby receiving a reciprocal motion of the piston through the connecting rod and being rotated thereby.

At least one centrifugal pendulum damper 30 may be built in the flywheel 10.

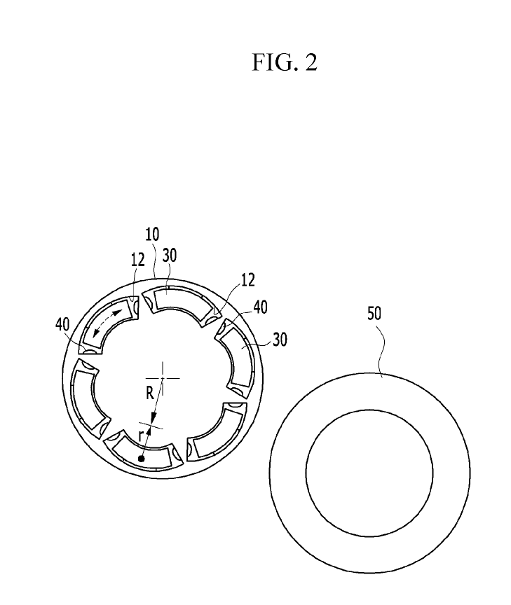

Referring to FIG. 2, a guide groove 12 made of an approximately circular arc shape may be formed at one side of the flywheel 10.

A plurality of guide grooves 12 may be disposed with a predetermined interval, or at predetermined intervals, in a circumferential direction.

In FIG. 2, the guide groove 12 is formed in a group of six, but the guide groove 12 may be formed in a group of four or eight or another number, etc.

The guide groove 12 may be formed near an outer edge of a radial direction of the flywheel 10.

The centrifugal pendulum damper 30 may be built in each guide groove 12. The centrifugal pendulum damper 30 may also be formed in a circular arc shape like the guide groove 12, however the centrifugal pendulum damper 30 may be formed to have a width and the length that are respectively smaller than the width and the length of the guide groove 12.

Accordingly, if the centrifugal pendulum damper 30 is inserted and received in each guide groove 12, each centrifugal pendulum damper 30 may be together rotated according to a rotational movement of the flywheel 10 and may be reciprocally moved in the guide groove 12 depending on a rotation change, or a rotational speed change, of the flywheel such that vibrations may be generated.

A buffer damper 40 of the guide groove 12 may be attached to a front end part of both sides, or of one side, of the flywheel 10 along a circumferential direction of each guide groove 12. The buffer damper 40 may be attached to be, or disposed to be, protruded inside the guide groove 12.

The buffer damper 40 may be made of a rubber or polymer material having an appropriate elastic property, however the material is not limited thereto.

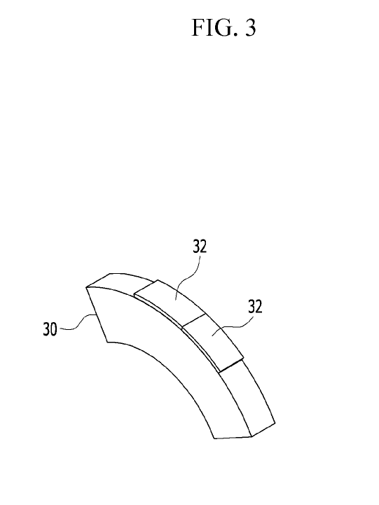

Referring to FIG. 3, a needle bearing 32 may be attached to an outer edge of the radial direction of the centrifugal pendulum damper 30 to reduce friction with the guide groove 12.

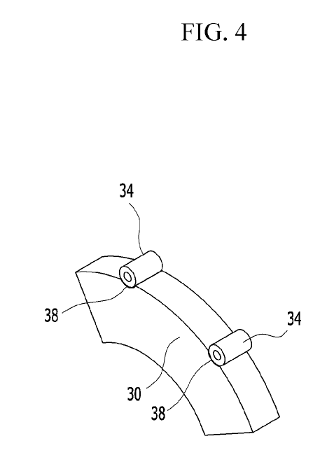

Alternatively, as shown in FIG. 4, at least one roller 34 may be mounted to the centrifugal pendulum damper 30 such that the smooth reciprocal motion of the centrifugal pendulum damper 30 may be controlled in the guide groove 12.

A roller receiving groove 38 may be formed at the outer edge of the radial direction of the centrifugal pendulum damper 30 in order for the roller 34 to stably roll on the outer edge of the radial direction of the centrifugal pendulum damper 30.

As well as the roller 34 and the needle bearing 32, other elements or apparatuses may be used to produce smooth reciprocal motion of the centrifugal pendulum damper 30.

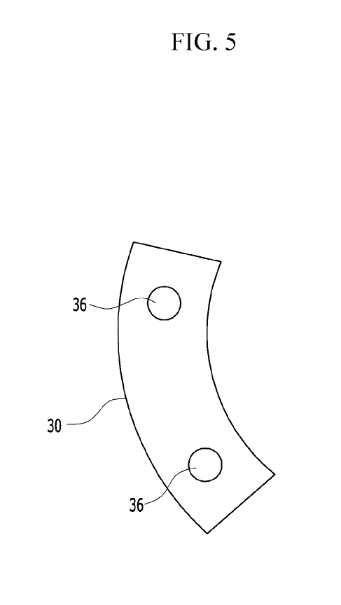

Referring to FIG. 2 and FIG. 5, a cover 50 may be mounted to one side of the flywheel 10 to prevent the centrifugal pendulum dampers 30 received, or disposed, inside the guide groove 12 from being separated.

The cover 50 may be formed of a ring shape, for example, with an appropriate size of a degree that may cover the guide groove 12 and the centrifugal pendulum damper 30, however the cover 50 may be of a circular plate shape, or another shape.

When the cover 50 is mounted to the flywheel 10, for example, using a rivet or a bolt, friction may be generated between the cover 50 and the centrifugal pendulum damper 30, to reduce this friction, at least one protrusion 36 that is protruded outside of the centrifugal pendulum damper 30 may be provided at one side of the centrifugal pendulum damper 30.

At least one protrusion 36 may be formed as shown in FIG. 5, however the protrusion 36 may be formed of other shapes.

At least one protrusion 36 may be interposed, or disposed, between the centrifugal pendulum damper 30 and the cover 50, thereby preventing direct friction between the centrifugal pendulum damper 30 and the cover 50.

If the centrifugal pendulum damper 30 is formed of the circular arc shape having a first radius r, the radius from the center point of the first radius r to the center point of the flywheel 10 is referred to as a second radius R, and the flywheel 10 is rotated by an angular speed Ω, a natural frequency f₀ of the centrifugal pendulum damper 30 may be determined by the equation below:

$${f}_{0} = \frac{Ω}{2 \cdot π} \sqrt{\frac{R}{r}}$$

If the natural frequency f₀ of the centrifugal pendulum damper 30 accords, or matches, with the frequency of the flywheel 10 by appropriately controlling the magnitudes of the first radius r and the second radius R, the vibration of the flywheel 10 may be absorbed, or reduced, by the centrifugal pendulum dampers 30.

That is, while the centrifugal pendulum dampers 30 are together rotated while receiving the centrifugal force due to a rotation of the flywheel 10, if the frequency of the flywheel 10 is changed, the centrifugal pendulum dampers 30 are continuously rotated by the rotational inertia and are rotated while having an inverse phase with respect to the flywheel 10, and the inverse phase vibration of the centrifugal pendulum damper 30 may offset the rotational change, or a rotational speed change, of the flywheel 10, thereby effectively reducing the vibration of the flywheel 10.

As described above, if the vibration of the flywheel 10 is reduced, power delivery of the engine through the flywheel 10 may be smoother.

For example, in the process that the rotational power of the engine is transmitted to the transmission input shaft of the flywheel 10, the rotation power change, or rotational speed change, from the flywheel 10 to the transmission input shaft is reduced such that stable shifting may be realized, thereby improving the NVH (Noise Vibration Hardness) characteristics of the vehicle.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A flywheel assembly comprising:
a flywheel mounted to a crankshaft of an engine to be integrally rotated with the crankshaft; and
at least one centrifugal pendulum damper installed to be reciprocally moved inside the flywheel.

2. The flywheel assembly of claim 1, wherein at least one guide groove is formed at one side of the flywheel; and
the at least one centrifugal pendulum damper is received inside the at least one guide groove.

3. The flywheel assembly of claim 2, wherein the at least one centrifugal pendulum damper and the guide groove comprise a circular arc shape.

4. The flywheel assembly of claim 2, wherein the at least one guide groove and the at least one centrifugal pendulum damper are disposed at a predetermined interval along a circumferential direction of the flywheel.

5. The flywheel assembly of claim 2, wherein the at least one guide groove and the at least one centrifugal pendulum damper are disposed near an outer edge in a radial direction of the flywheel.

6. The flywheel assembly of claim 2, wherein a width and a length of the at least one centrifugal pendulum damper are smaller than a respective width and length of the guide groove.

7. The flywheel assembly of claim 2, wherein a buffer damper is attached to a front end part of both sides of the flywheel along a circumferential direction of the guide groove.

8. The flywheel assembly of claim 2, wherein a needle bearing or a roller is mounted to an outer edge of a radial direction of the centrifugal pendulum damper.

9. The flywheel assembly of claim 2, wherein the flywheel is installed with a cover to prevent at least one centrifugal pendulum damper from being separated from the flywheel.

10. The flywheel assembly of claim 9, wherein the at least one centrifugal pendulum damper includes at least one protrusion for reducing friction between the centrifugal pendulum damper and the cover.

11. The flywheel assembly of claim 9, wherein the cover comprises a ring shape.

12. The flywheel assembly of claim 8, wherein a roller receiving groove is formed at the outer edge of the radial direction of the centrifugal pendulum damper.
